(19) United States
(12) Patent Application Publication
(10) Pub. No.: US 2003/0188945 A1
(43) Pub. Date: Oct. 9, 2003

(54) HANDLE ASSEMBLY

(76) Inventor: Fei-Chen Lee, Yung He City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/354,376

(22) Filed: Jan. 30, 2003

Related U.S. Application Data
(62) Division of application No. 10/117,608, filed on Apr. 5, 2002.

(51) Int. Cl. A45C 13/00; A45C 13/30; A45C 13/10; E05B 1/00; A47J 45/00; A47B 95/02

(52) U.S. Cl. 190/119; 190/115; 24/578.17; 16/114.1

(57) ABSTRACT

The present invention relates to a handle assembly and a buckle assembly. The handle assembly includes a seat having a circular buckle projecting therefrom for guiding the handle bar by means of a slot and a cover cooperating with the seat to support an extending portion of the handle bar, and the buckle-assembly includes a female buckle component assembly and a male buckle component having a recess at one end thereof for receiving a female buckle component and an engagement member close to the other end thereof for matching an engagement member of a switching plate in close condition.

### FIELD OF THE INVENTION

The present invention is related to a handle assembly and a buckle assembly and more particularly, to a handle assembly and a buckle assembly of a briefcase.

### BACKGROUND OF THE INVENTION

All the while, a briefcase is an essential utensil for everybody to carry documents and stationery. A user usually selects a suitable briefcase according to the function and the practicability of the briefcase. Hence there are several kinds of briefcases provided in response to the requirements of users. However, those current briefcases are still not fit in with the requirements of users.

Referring to FIGS. 1(a) and 1(b), they illustrate a briefcase with a handle bar of the prior art. The briefcase has a buckle assembly including a rough stud 11 and an engagement element 12. The buckle assembly is so rough that the cover 13 of the briefcase can't be hooked tightly and stably. Moreover, the rough stud 11 and the engagement element 12 always engage by means of a spring, which is disposed inside the engagement element 12. Hence the rough stud 11 and the engagement element 12 could be broken after be used repeatedly for a period. On the other hand, the briefcase has a typical handle bar 16 fixed on the briefcase, but the typical handle bar 16 is not convenient to be carried and can't be extended in response to the requirements of a user.

Therefore, it is tried to rectify this drawback by the present applicant.

### SUMMARY OF THE INVENTION

It is therefore an objective of the present invention to provide a buckle assembly. According to an aspect of the present invention, the buckle assembly includes a female buckle component assembly having a female buckle component which has a first fixing apparatus, and a switching plate having a first engagement member and pivotally connected to the female buckle component for closing and opening operations, and a male buckle component having a second fixing apparatus, a recess at one end thereof for receiving the female buckle component, and a second engagement member close to the other end thereof for matching the first engagement member of the switching plate in close condition.

Certainly, the first engagement member could be a buckle, and the second engagement member could be a hole for receiving the buckle.

Certainly, the first and second fixing apparatus could be buckles.

Preferably, the female buckle component assembly of the buckle assembly is fixed on a cover of an article by means of the first fixing apparatus, on the other hand, the male buckle component of the buckle assembly is fixed on a main body of the article by means of the second fixing apparatus;

Preferably, the article is a brief case.

According to another aspect of the present invention, the handle assembly includes a handle bar having an extending portion at each of the two ends thereof, each of the extending portions having a slot which has half circular shape formed at each of the two ends of the slot, and two holders, each of which is installed at a corresponding end of the handle bar for holding the extending portion, further comprising a seat having a circular buckle projecting therefrom for guiding the handle bar by means of the slot and a cover cooperating with the seat to support the extending portion of the handle bar, whereby, the slot of the extending portion of the handle bar is capable of sliding against and stopping by the circular buckle of the seat.

Certainly, the seats of the holders of the handle assembly could be fixed on a top surface of an article.

Preferably, the article is a briefcase.

The foregoing and other features and advantages of the present invention will be more clearly understood through the following descriptions with reference to the drawings, wherein:

### BRIEF DESCRIPTION OF THE DRAWING

FIGS. 1(a) and (b) illustrate a typical briefcase of the prior art;

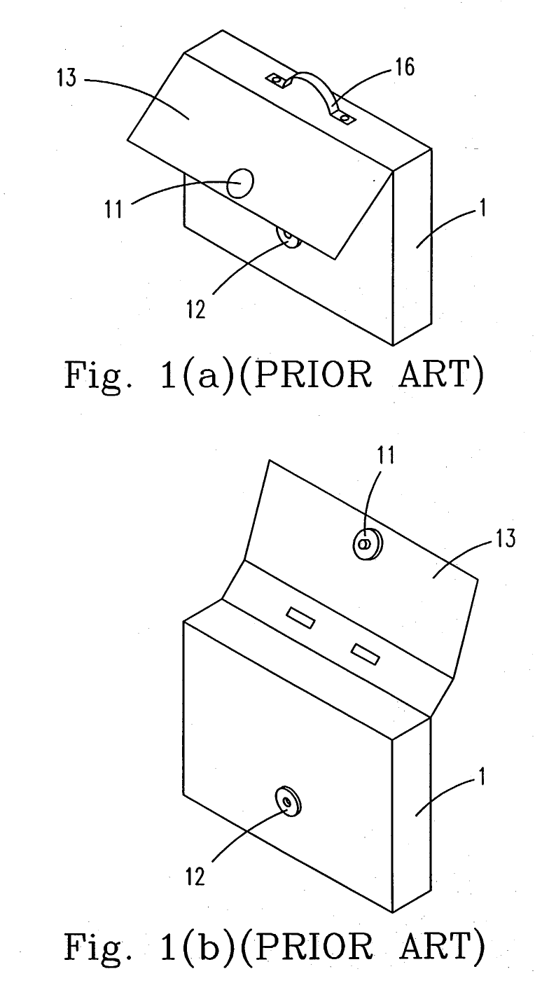

FIGS. 2(a) and (b) illustrate a first preferred embodiment of a buckle assembly of a briefcase of the present invention; and

FIGS. 3(a) and (b) illustrate a second preferred embodiment of a handle assembly of a briefcase of the present invention.

### DETAILED DESCRIPTION OF THE PREFERRED EMBODIMENTS

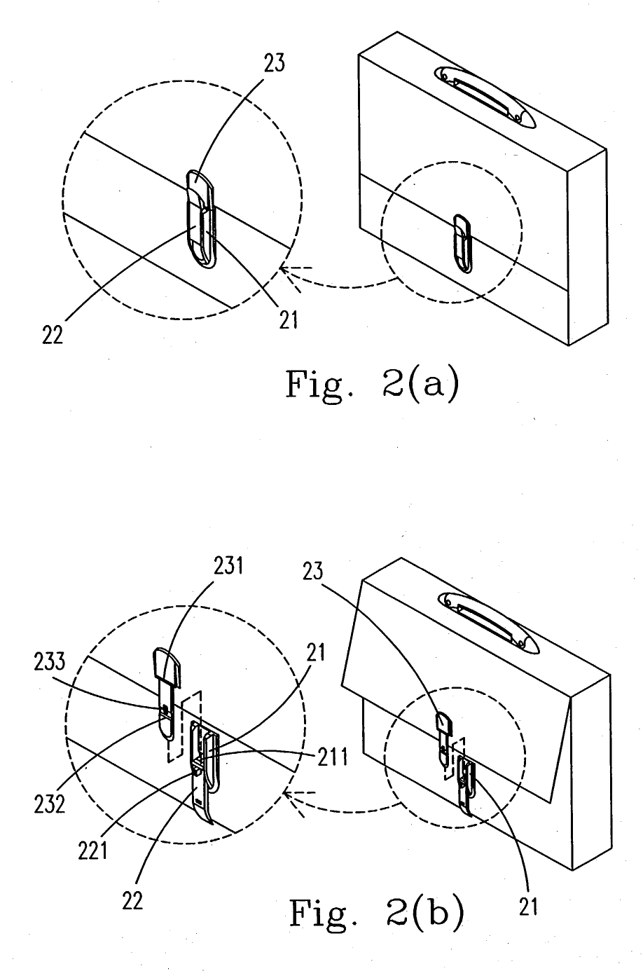

Please refer to FIGS. 2(a) and 2(b). They illustrate a preferred embodiment of the present invention of a buckle assembly. The buckle assembly includes a female buckle component assembly and a male buckle component 23. The female buckle component assembly further comprises a female buckle component 21 and a switching plate 22. The female buckle component 21 has a first fixing apparatus 211. The switching plate 22 has a first engagement member 221 and is pivotally connected to said female buckle component 21 for closing and opening operations. The male buckle component 23 further includes a second fixing apparatus 231, a recess 232 at one end thereof for engaging with the first fixing apparatus 211, and a second engagement member 233 close to the other end thereof for matching said first engagement member 221 of said switching plate 22 in close condition. FIG. 2(a) shows the switching plate 22 in close condition and FIG. 2(b) shows the switching plate 22 in open condition. The first engagement member 221, said first fixing apparatus 211 and said second fixing apparatus 231 are buckles, and the second engagement member is 233 a hole for receiving said buckle 221. The female buckle component assembly of said buckle assembly is fixed on a cover of an article by means of said first fixing apparatus 211. On the other hand, said male buckle component 23 of said buckle assembly is fixed on a main body of said article by means of said second fixing apparatus 231.

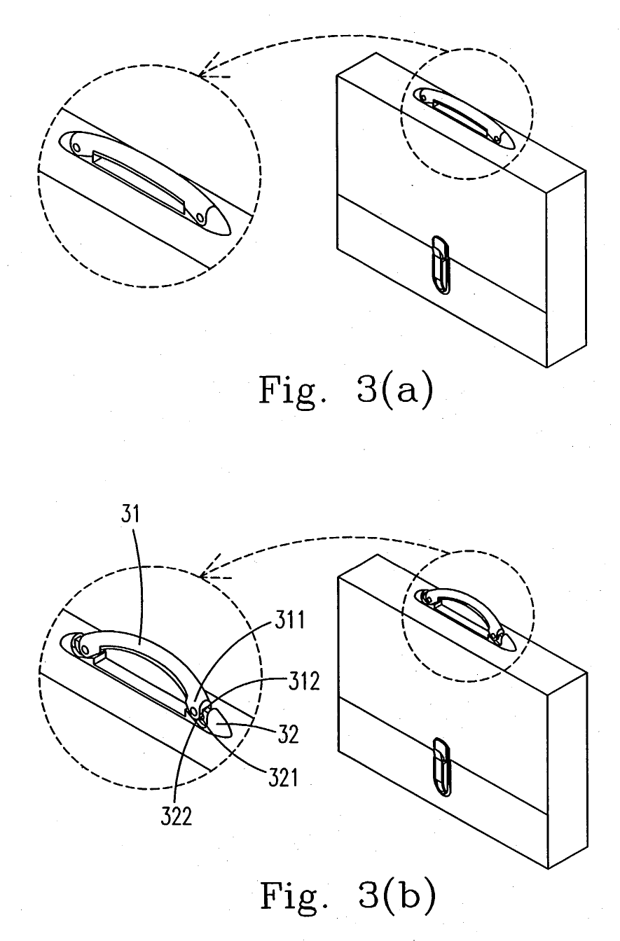

FIGS. 3(a) and 3(b) illustrate a preferred embodiment of the present invention of a handle assembly. The handle assembly includes a handle bar 31 and two holders 32. The handle bar 31 further includes an extending portion 311 at each of the two ends thereof. Each of said extending portions 311 has a slot (not shown) which has half circular shape formed at each of said two ends of said slot. Each of two holders 32 is installed at a corresponding end of said handle bar 31 for holding said extending portion 311, and further includes a seat 321 having a circular buckle projecting 322 therefrom for guiding said handle bar 31 by means of said slot, and a cover 312 cooperating with said seat 321 to support said extending portion 311 of said handle bar 31. Whereby, said slot of said extending portion 311 of said handle bar 31 is capable of sliding against and stopping by said circular buckle 322 of said seat 321. The seat of said holders of said handle assembly is fixed on a top surface of the briefcase.

The briefcase has a buckle assembly and a handle assembly of the present invention is really useful. Because the female buckle component assembly and a male buckle component are engaged by means of a latch and a switching plate, the buckle assembly can engage the cover of the briefcase tightly and stably and the buckle assembly is more durable than a typical one operated by means of a spring. On the other hand, the handle assembly of the present invention can be extended in response to the requirements of a user and it is really easy to be operated. In conclusion, the present invention has practicability and should be a useful invention.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A buckle assembly comprising:
a female buckle component assembly having:
a female buckle component having a first fixing apparatus; and
a switching plate having a first engagement member and pivotally connected to said female buckle component for closing and opening operations; and
a male buckle component having a second fixing apparatus, a recess at one end thereof for receiving said female buckle component, and a second engagement member close to the other end thereof for matching said first engagement member of said switching plate in close condition.

2. The buckle assembly as claimed in claim 1, wherein said first engagement member is a buckle, and the second engagement member is a hole for receiving said buckle.

3. The buckle assembly as claimed in claim 1, wherein said first and second fixing apparatus are buckles.

4. The buckle assembly as claimed in claim 1 wherein said female buckle component assembly of said buckle assembly is fixed on a cover of an article by means of said first fixing apparatus, on the other hand, said male buckle component of said buckle assembly is fixed on a main body of said article by means of said second fixing apparatus.

5. The buckle assembly as claimed in claim 4 wherein said article is a brief case.

6. A handle assembly comprising:
a handle bar having an extending portion at each of the two ends thereof, each of said extending portions having a slot which has half circular shape formed at each of said two ends of said slot; and
two holders, each of which is installed at a corresponding end of said handle bar for holding said extending portion, further comprising:
a seat having a circular buckle projecting therefrom for guiding said handle bar by means of said slot; and
a cover cooperating with said seat to support said extending portion of said handle bar;
whereby, said slot of said extending portion of said handle bar is capable of sliding against and stopping by said circular buckle of said seat.

7. The handle assembly as claimed in claim 6, wherein said seats of said holders of said handle assembly is fixed on a top surface of an article.

8. The handle assembly as claimed in claim 7, wherein said article is a briefcase.
